(19) United States
(12) Patent Application Publication
(10) Pub. No.: US 2025/0175735 A1
(43) Pub. Date: May 29, 2025

(54) HOUSING OF SOUND PRODUCTION DEVICE, SOUND PRODUCTION DEVICE, AND ELECTRONIC APPARATUS

(71) Applicant: GOERTEK INC., Weifang, Shandong (CN)

(72) Inventors: Chunfa LIU, Weifang, Shandong (CN); Cuicui WANG, Weifang, Shandong (CN); Meiling LI, Weifang, Shandong (CN); Chun LI, Weifang, Shandong (CN)

(21) Appl. No.: 18/843,786

(22) PCT Filed: Feb. 24, 2023
(86) PCT No.: PCT/CN2023/078104

§ 371 Date: Sep. 4, 2024

(30) Foreign Application Priority Data
Jun. 30, 2022 (CN) 202210770718.3

(51) Int. Cl. H04R 1/28; H04R 1/02

(52) U.S. Cl. CPC H04R 1/2888; H04R 1/025; H04R 2201/029

(57) ABSTRACT

A housing of a sound production device, a sound production device, and an electronic apparatus. At least a part of the housing is a first support housing, and the first support housing includes a metal frame and an organic aerogel material, wherein the metal frame is a porous framework with a pore channel structure, and the organic aerogel material is distributed on a surface of the metal frame and in the pore channel structure.

### TECHNICAL FIELD

The present disclosure relates to a technical field of electronic apparatus, and more specifically, to a housing of a sound production device, a sound production device, and an electronic apparatus.

### DESCRIPTION OF RELATED ART

With the rapid development of the 5G era, electroacoustic devices are developing towards being lightweight, intelligent, high-power, and high-frequency. In a loudspeaker module, characteristics, such as weight, thickness, rigidity, etc., of a housing of the loudspeaker have a certain degree of influence on the acoustic performance of the loudspeaker.

In the related art, in general, the housing of a loudspeaker is made of plastic materials such as polycarbonate, polyamide, polypropylene, acrylonitrile-butadiene-styrene, etc., but the plastic housing generally has low rigidity and a large shrinkage rate, which may lead to poor dimensional stability of the housing of the loudspeaker and easily cause resonance during the sound production of the loudspeaker, thereby affecting the acoustic performance and acoustic effect of the loudspeaker. In addition, the thermal conductivity of the plastic housing is poor, which is not conducive to the heat dissipation of the loudspeaker.

### SUMMARY

An object of the present disclosure is to provide a new technical solution for a housing of a sound production device, a sound production device, and an electronic apparatus.

According to a first aspect of the present disclosure, a housing of a sound production device is provided, wherein at least a part of the housing is a first support housing, and the first support housing includes a metal frame and an organic aerogel material, wherein the metal frame is a porous framework with a pore channel structure, and the organic aerogel material is distributed on a surface of the metal frame and in the pore channel structure.

Optionally, a size of the metal frame in a thickness direction of the first support housing is 0.1 mm to 3 mm.

Optionally, the metal frame has a surface density of 0.4 kg/m² to 1.5 kg/m²; and/or, the pore channel structure has a pore size of 80 μm to 400 μm.

Optionally, the metal frame is a metal woven mesh or a metal hollow mesh; or, the metal frame is made of metal fiber porous material or open-cell metal foam material.

Optionally, the first support housing has a bending modulus of 1 GPa to 10 GPa; and/or, the first support housing has a bending strength of 30 MPa to 100 MPa.

Optionally, the first support housing has a density of 0.3 g/cm³ to 1.2 g/cm³.

Optionally, the first support housing has a thickness of 0.2 mm to 3 mm.

Optionally, the first support housing has a shrinkage rate of 5% to 10%.

Optionally, the first support housing has an impact strength of 9 kJ/m² to 80 kJ/m².

Optionally, the first support housing has a thermal conductivity greater than or equal to 1 W/m*K.

Optionally, a mass of the organic aerogel material accounts for 30% to 70% of the total mass of the first support housing.

Optionally, the organic aerogel material is at least one of polyimide aerogel, polyamide aerogel, polyester aerogel, aldehyde aerogel, polyolefin aerogel or polysaccharide aerogel.

Optionally, the metal frame and the organic aerogel material are integrally formed by injection molding or mold pressing.

Optionally, the housing further includes a second support housing, wherein the second support housing is connected to the first support housing by integral injection molding or by adhesive;
wherein the second support housing is made of at least one of PC or its modified materials, PA or its modified materials, PPS or its modified materials, PP or its modified materials, ABS or its modified materials, LCP or its modified materials, PEI or its modified materials, phenolic resin or its modified materials, epoxy resin or its modified materials, unsaturated polyester or its modified materials, stainless steel or aluminum alloy, magnesium alloy, or metal-based composite materials.

According to a second aspect of the present disclosure, a sound production device is provided, wherein the sound production device includes a sound production unit and a housing of the sound production device according to the first aspect, wherein the sound production unit is disposed in the housing.

According to a third aspect of the present disclosure, an electronic apparatus including the sound production device described in the second aspect is provided.

According to an embodiment of the present disclosure, a technical effect of the present disclosure is as follows:

The present disclosure adopts a metal frame combined with an organic aerogel material as at least a part of the housing of the sound production device, and the metal frame is a porous framework with a pore channel structure, and the organic aerogel material is distributed on a surface of the metal frame and in the pore channel structure.

In the above-mentioned housing structure, the interior of the organic aerogel material has an interlaced porous network structure, which makes the housing of the sound production device lighter, and the metal frame serving as a supporting framework of the housing not only improves the rigidity of the housing, but also can limit the shrinkage of the organic aerogel material and thus can improve the dimensional stability of the housing.

When the above-mentioned housing is applied to a sound production device, on the one hand, the sound production device can achieve the design requirements of being lightweight and miniaturized, and on the other hand, it can also meet the requirements for acoustic stability performance. In addition, the metal frame has good thermal conductivity, which improves the heat dissipation performance of the sound production device.

Additional features and advantages of the present disclosure will become apparent from the following detailed description of exemplary embodiments of the present disclosure with reference to the accompanying drawings.

### BRIEF DESCRIPTION OF DRAWINGS

The accompanying drawings, which are incorporated in and constitute a part of the specification, illustrate embodiments of the present disclosure and, together with the description, serve to explain the principles of the present disclosure.

FIG. 1 is a schematic structural diagram of a sound production device according to the present disclosure.

FIG. 2 is a schematic diagram showing an organic aerogel material distributed on a surface and in a pore channel structure of a metal hollow mesh according to the present disclosure.

FIG. 3 is a schematic diagram showing an organic aerogel material distributed on a surface and in a pore channel structure of a metal woven mesh according to the present disclosure.

FIG. 4 is a schematic diagram showing an organic aerogel material distributed on a surface and in a pore channel structure of a porous metal material according to the present disclosure.

FIG. 5 is a THD curve diagram explaining the housing being applied to a sound production device in Example 1 and Comparative Example 1 provided by the present disclosure.

The reference numbers in the drawings are follows:
10: housing; 11: first support housing; 12: second support housing; 111: porous metal material; 112: metal woven mesh; 113: metal hollow mesh; 114: organic aerogel material; 20: sound production unit.

### DETAILED DESCRIPTIONS

Various exemplary embodiments of the present disclosure will now be described in detail with reference to the accompanying drawings. It should be noted that the relative arrangement of components and steps, the numerical expressions and numerical values set forth in these embodiments do not limit the scope of the present disclosure unless specifically stated otherwise.

The following description of at least one exemplary embodiment is merely illustrative in nature and is in no way intended to limit the disclosure, its applications, or uses.

Technologies, methods, and equipment known to those skilled in the art may not be discussed in detail, but where appropriate, the technologies, methods, and equipment should be considered as part of the specification.

In all examples shown and discussed herein, any specific values should be interpreted as merely exemplary and not as limiting. Therefore, other examples of the exemplary embodiments may have different values.

It should be noted that like reference numerals and letters refer to similar items in the following drawings, and therefore, once an item is defined in one drawing, it need not be further discussed in subsequent drawings.

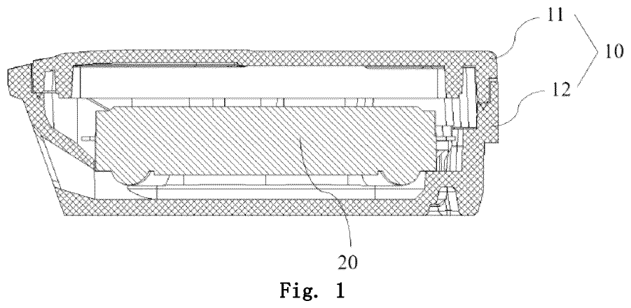

As illustrated in FIGS. 1 to 5, according to a first aspect of the present disclosure, a housing 10 of a sound production device is provided. At least a part of the housing 10 is a first support housing 11, and the first support housing 11 includes a metal frame and an organic aerogel material 114, wherein the metal frame is a porous framework with a pore channel structure, and the organic aerogel material 114 is distributed on a surface of the metal frame and in the pore channel structure.

Specifically, the housing 10 of the sound production device has a certain protective effect on the sound production device, and has a certain influence on the acoustic performance and other aspects of the sound production device. In the embodiment, at least a part of the housing 10 of the sound production device, namely the first support housing 11, is made of a metal frame and an organic aerogel material 114 distributed on a surface of the metal frame and in the pore channel structure.

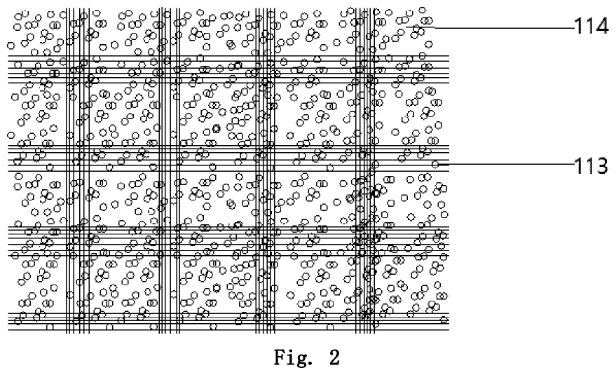

As illustrated in FIGS. 2 to 4, in the above structure, the organic aerogel material 114 is distributed on the surface of the metal frame and in the pore channel structure, that is, the organic aerogel material 114 can fill the pore channel structure and cover an outer wall and an inner wall (a wall of the pore channel structure) of the metal frame. The metal frame is a framework with a porous structure made of metal material. The porous structure may be, for example, a metal woven mesh 112 or a metal hollow mesh 113 formed by a processing technology, or may be prepared by selecting a material itself having a pore channel structure. For example, it may be made of a metal fiber porous material or an open-cell metal foam material. The organic aerogel material 114 is a material made of organic polymer materials, such as polyimide aerogel, polyamide aerogel, polyester aerogel, aldehyde aerogel, polyolefin aerogel, polysaccharide aerogel, etc. In practical applications, the type of metal frame and the type of organic aerogel can be selected according to actual needs, and it is not limited to the present disclosure.

The housing 10 of the sound production device prepared by using the above structure has an organic aerogel material 114 with an interlaced porous network structure inside, so that the housing 10 of the sound production device prepared is light in weight. The metal frame, as a supporting framework of the housing 10, not only improves the rigidity of the housing 10, but also can limit the shrinkage of the organic aerogel material 114, thereby reducing the shrinkage rate of the organic aerogel and improving the dimensional stability of the housing 10. When the prepared housing 10 is applied to a sound production device, the combination of the organic aerogel material 114 and the metal frame can, on the one hand, achieve the design requirements of lightweight and miniaturized sound production device, and on the other hand, make the housing 10 have good dimensional stability, which can prevent the sound production device from causing resonance during a sound production process, thereby meeting the acoustic stability requirements for the sound production device.

In addition, since the metal frame is made of metal material, it has a higher thermal conductivity coefficient and a higher specific surface area, which can quickly exchange heat with gas and liquid, can conduct heat through the movement of a large number of free electrons, and has a high thermal conductivity, thereby effectively conducting and dissipating heat and further improving the heat dissipation performance of the sound production device. Furthermore, the first support housing 11 prepared by organic aerogel contains certain hydrophobic groups, has a small surface pore size, and has a hydrophobic angle at 80° or less, so that the prepared housing 10 has good hydrophobicity and can be used in high humidity environments without structural collapse.

It will be understood that in the present disclosure, the metal frame is combined with the organic aerogel material 114 so that the shrinkage rate of the finally prepared first support housing 11 can be reduced to 5% to 10%, which effectively suppresses the shrinkage rate of the organic aerogel and greatly improves the structural stability of the housing 10. The shrinkage rate of the first housing can be adjusted by adjusting a mass proportion of the organic aerogel in the first support housing 11. If the proportion of organic aerogel in the first support housing 11 is too high, the shrinkage rate of the prepared first housing may also be high, affecting the structural stability of the first support housing 11 during molding. If the proportion of organic aerogel is too low, the proportion of the metal frame may be higher, which may lead to an increase in the mass of the housing 10.

In the present disclosure, the mass proportion of the organic aerogel in the first support housing 11 is 30% to 70%, for example, 30%, 40%, 50%, 60%, 70%, etc., which can balance between the structural stability and lightweight requirements for the housing 10, so that the shrinkage rate of the first support housing 11 can be maintained at 5% to 10%.

Optionally, a size of the metal frame in a thickness direction of the first support housing 11 is 0.1 mm to 3 mm.

Specifically, the size of the metal frame in the thickness direction of the first support housing 11 may affect the thickness of the final prepared housing 10. If the thickness of the metal frame is too thick, the overall mass of the housing 10 may become heavier, which is not conducive to the lightweight and miniaturized design requirements for the sound production device. If the thickness of the metal frame is too thin, it cannot meet the structural strength requirement for the housing 10, resulting in insufficient rigidity of the housing 10 and failure to achieve the purpose of protecting the sound production device. In addition, too thin a thickness has limited effect on reducing the shrinkage of the organic aerogel, so that the structural stability of the housing 10 becomes low. In the embodiment, the thickness of the metal frame is 0.1 mm to 3 mm, for example, 0.1 mm, 0.2 mm, 0.5 mm, 0.7 mm, 0.9 mm, 1 mm, 1.2 mm, 1.5 mm, 1.8 mm, 2 mm, 2.5 mm, 3 mm, etc. The metal frame with a thickness within this range can balance between the strength and the lightweight requirements for the housing 10.

Optionally, the metal frame has a surface density of 0.4 kg/m² to 1.5 kg/m²; and/or, the pore channel structure has a pore size of 80 μm to 400 μm.

Specifically, the pore size of the pore channel structure on the metal frame is inversely proportional to the surface density of the metal frame, that is, the larger the pore size of the pore channel structure, the smaller the surface density. If the pore size of the pore channel structure is too large, that is, the surface density of the metal frame is smaller, the metal frame may not have a good effect on reinforcing the rigidity of the housing 10, and may not be effective in suppressing the shrinkage of the aerogel, which may easily lead to deterioration of the structural stability of the housing 10. When the pore size of the pore channel structure is too small, that is, the surface density of the metal frame is too large, the metal frame may account for a large proportion of the total mass of the housing 10, and in actual production, it is also difficult for the organic aerogel to enter the pore channel structure, resulting in poor bonding between the metal frame and the organic aerogel material 114, which is not conducive to the design requirements of lightweight and miniaturized sound production devices.

In the embodiment, the surface density of the metal frame is 0.4 kg/m² to 1.5 kg/m², for example, 0.4 kg/m², 0.5 kg/m², 0.8 kg/m², 0.9 kg/m², 1 kg/m², 1.2 kg/m², 1.5 kg/m², etc.; or, the pore size of the pore channel structure is 80 μm to 400 μm, for example, 10 μm, 85 μm, 90 μm, 95 μm, 100 μm, 150 μm, 180 μm, 200 μm, 250 μm, 300 μm, 360 μm, 400 μm, etc. At this time, the metal frame has good bonding with the organic aerogel, and the metal frame has excellent reinforcement effect on the rigidity of the housing 10, which can meet the requirements of the acoustic performance and structural performance of the sound production device at the same time.

Optionally, the metal frame is a metal woven mesh 112 or a metal hollow mesh 113; or, the metal frame is made of metal fiber porous material or open-cell metal foam material.

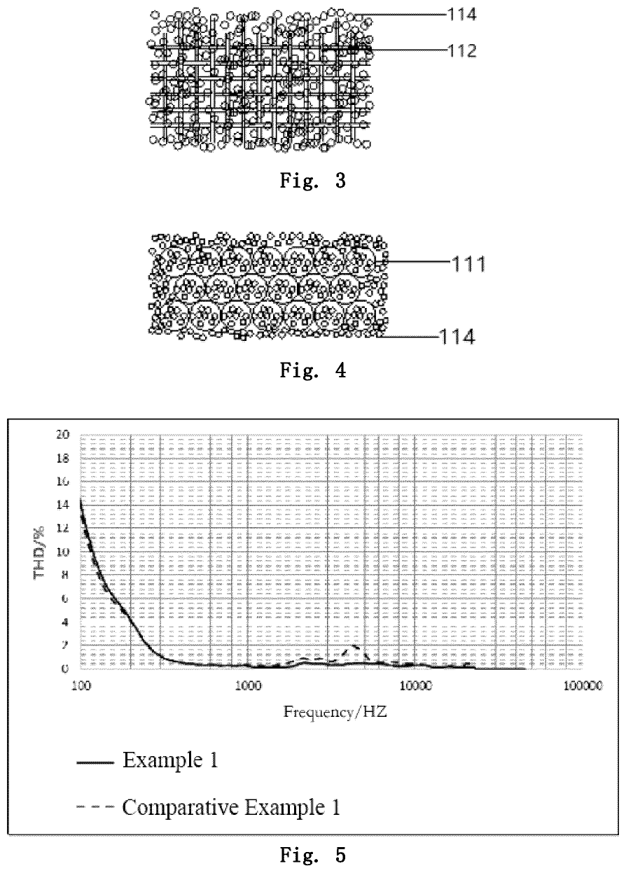

Specifically, the metal frame may be a porous framework having a pore channel structure formed by a processing technology, or may be a porous framework prepared by using a porous metal material 111 itself having a pore channel structure. Referring to FIG. 2 and FIG. 3, the metal frame formed by the processing technology, such as the metal woven mesh 112 and the metal hollow mesh 113, has high process maturity and low processing cost and can be used for mass production. Referring to FIG. 4, the metal materials with a pore channel structure, such as metal fibers or open-cell metal foams, may be applied to sound production devices with precision requirements. The specific selection can be based on actual product needs and processing requirements, and it is not limited to the present disclosure.

Optionally, the first support housing has a bending modulus of 1 GPa to 10 GPa; and/or, the first support housing has a bending strength of 30 MPa to 100 MPa.

Specifically, the bending modulus or bending strength can characterize the structural stability of the first support housing 11. When the bending modulus or bending strength is too large, an anti-bending deformation margin of the first support housing 11 may be too large and the cost may increase. When the bending modulus or bending strength is too small, the rigidity of the first support housing 11 cannot meet the design requirements for the housing 10 of the sound production device, resulting in poor structural stability. In the embodiment, in order to balance between production cost and structural stability, the bending modulus is set to 1 GPa to 10 GPa, for example, 1 GPa, 3 GPa, 5 GPa, 8 GPa, 10 GPa, etc.; or, the bending strength is set to 30 MPa to 100 MPa, for example, 30 MPa, 40 MPa, 50 MPa, 60 MPa, 80 MPa, 100 MPa, etc. Preferably, the bending modulus and the bending strength may be simultaneously set within the above ranges.

In an embodiment, the bending modulus of the first support housing 11 can be adjusted by adjusting the bending modulus of the metal frame. For example, by setting the bending modulus of the metal frame to 50 GPa to 200 GPa, for example, 50 GPa, 60 GPa, 80 GPa, 100GPa, 150 GPa, 20 GPa, etc., combined with the organic aerogel material 114, the bending modulus of the first support housing 11 can be set to 1 GPa to 10 GPa. Or, the bending strength of the first support housing 11 can be adjusted by adjusting the bending strength of the metal frame. For example, by setting the bending strength of the metal frame at 80 MPa to 250 MPa, for example, 10 MPa, 90 MPa, 100 MPa, 120 MPa, 150 MPa, 180 MPa, 200 MPa, 220 MPa, 250 MPa, etc., combined with the organic aerogel material 114, the bending strength of the first support housing 11 can be set to 30 MPa to 100 MPa.

It should be noted that when the bending modulus or bending strength of the metal frame is limited to the above ranges, the mass proportion of the organic aerogel can also be balanced, so as to avoid the metal frame having an excessively high proportion, which affects the overall weight of the housing 10.

Optionally, the first support housing has a density of 0.3 g/cm³ to 1.2 g/cm³.

Specifically, when the density of the first support housing 11 is too high, for the housing 10 of the same volume, the mass is easily become too high, which is not conducive to the lightweight requirement of the sound production device. When the density of the first support housing 11 is too low, for the housing 10 of the same mass, the volume is easily become larger, which is not conducive to the miniaturization requirement of the sound production device. In the embodiment, the organic aerogel material 114 is combined with the metal frame, and the organic aerogel has an interlaced porous structure, which can maintain the density of the first support housing 11 within 0.3 g/cm³ to 1.2 g/cm³ without increasing its mass or volume, thereby achieving the requirements of lightweight and miniaturization of the sound production device.

In some embodiments, the thickness of the first support housing 11 is 0.2 mm to 3 mm, for example, 0.2 mm, 0.3 mm, 0.5 mm, 0.8 mm, 1 mm, 1.5 mm, 1.8 mm, 2 mm, 2.5 mm, 3 mm, etc. If the thickness of the first support housing 11 is less than 0.2 mm, the rigidity of the housing 10 may be insufficient. If the thickness of the first support housing 11 is greater than 3 mm, the weight of the housing 10 may be too heavy.

In some embodiments, under the test standard of ASTM D-256, the first support housing 11 has an impact strength of 9 kJ/m² to 80 kJ/m², for example, 9 kJ/m², 10 kJ/m², 12 kJ/m², 15 kJ/m², 18 kJ/m², 20 kJ/m², 25 kJ/m², 32 kJ/m², 37 kJ/m², 40 kJ/m², 50 kJ/m², 60 kJ/m², 70 kJ/m², 80 kJ/m², etc., which can ensure that the housing 10 is not easily deformed when subjected to impact. When the housing 10 falls, if the impact strength of the first support housing 11 is less than 9 kJ/m², the housing 10 may be easily deformed, causing the sound production unit 20 in the sound production device to be impacted.

In an embodiment, the first support housing 11 has a thermal conductivity greater than or equal to 1 W/m*K. In actual production, a metal frame with a larger thermal conductivity may be selected as the porous framework of the first support housing 11, and combined with the organic aerogel material 114 to improve the heat dissipation performance of the sound production device. In an embodiment, the first support housing 11 may be provided as a housing corresponding to a front sound cavity of the sound production device, or as a housing corresponding to a rear sound cavity of the sound production device, and the design is specifically based on actual needs.

In an embodiment, the metal frame and the organic aerogel material 114 may be integrally formed by injection molding or mold pressing to further improve the structural stability of the first support housing and to protect the housing 10 from separation between materials when subjected to impact or falling, thereby extending the service life of the housing 10.

Optionally, referring to FIG. 1, the housing 10 further includes a second support housing 12, and the second support housing 12 is connected to the first support housing 11 by integral injection molding or by adhesive. The second support housing 12 is made of at least one of PC or its modified materials, PA or its modified materials, PPS or its modified materials, PP or its modified materials, ABS or its modified materials, LCP or its modified materials, PEI or its modified materials, phenolic resin or its modified materials, epoxy resin or its modified materials, unsaturated polyester or its modified materials, stainless steel or aluminum alloy, magnesium alloy, or metal-based composite materials.

The present disclosure also provides a sound production device, as illustrated in FIG. 1, including the housing 10 of the sound production device according to any of the above embodiments, and the sound production device further includes a sound production unit 20 arranged in the housing 10 for performing electroacoustic conversion to achieve the sound production performance of the sound production device. Here, at least a part of the housing 10 is made of the above-mentioned first support housing, wherein the first support housing, through the combination of the metal frame and the organic aerogel, can improve the structural stability of the housing 10 and reduce the weight of the housing, meet the design requirements of lightweight and miniaturized sound production device, and also improve the acoustic performance and heat dissipation performance of the sound production device. Optionally, the sound production device may be a loudspeaker module.

The present disclosure also provides an electronic apparatus, which includes the sound production device according to the above embodiments of the present disclosure. The electronic apparatus may be a mobile phone, a laptop computer, a tablet computer, a virtual reality (VR) device, an augmented reality (AR) device, a true wireless Bluetooth (TWS) headset, a smart speaker, etc., but it is not limited thereto.

In order to make the technical solutions and corresponding technical effects of the present disclosure apparent, the following embodiment and comparative embodiment are specifically provided in the present disclosure to specifically illustrate the technical solutions.

### Example 1

This Example provided a housing 10 of a sound production device made of an organic aerogel material 114 and a metal frame, wherein the organic aerogel material 114 was polyimide aerogel, and the metal frame was a metal woven mesh 112. Referring to FIG. 3, the specific preparation method was as follows:
Step 1: 50 g of polyamidic acid salt was taken and a polyamidic acid hydrogel with a mass fraction (solid content) of 15% was prepared.
Step 2: The polyamidic acid hydrogel prepared in the Step 1 was heated to 60° C. and injection molded into a frame structure of a metal woven mesh 112 to obtain a housing 10 structure.
Step 3: The housing 10 structure prepared in the Step 2 was frozen at −40° C. for 1 hour, dried at a vacuum degree of <100 Pa for 2 hours, and imidized at 350° C. for 2 hours to obtain a polyimide aerogel housing 10 including a metal frame.

### Comparative Example 1

This comparative embodiment provided a PC housing 10 made of PC material, the outer dimensions of which were consistent with those of the housing 10 in Example 1, and the specific preparation process was omitted.

The polyimide aerogel housing 10 including a metal frame in Example 1 and the PC housing 10 in Comparative Example 1 were weighed, and bending modulus and thermal conductivity thereof were measured, and the results are shown in Table 1 below:

TABLE 1
Comparison of weight, bending modulus and thermal
conductivity of housing

| | | housing of |
|---|---|---|
| | housing of | Comparative |
| Performance parameters | Example 1 | Example 1 |
| Weight/mg | 260 | 500 |
| Bending modulus/GPa | 9 | 3.4 |
| Thermal conductivity/(W/m*K) | 300 | 0.2 |

It can be seen from Table 1 that the weight of the polyimide aerogel housing 10 including a metal frame obtained in Example 1 was reduced by 240 mg, the bending modulus was increased by 5.6 GPa and the thermal conductivity was also higher, as compared to the PC housing 10 in Comparative Example 1.

It is confirmed that the housing 10 of the sound production device provided by the present disclosure is lighter in weight, which is conducive to the design requirements of lightweight and miniaturized sound production device. The housing 10 of the sound production device provided by the present disclosure has a higher specific modulus, that is, a greater rigidity, which can improve the structural stability of the housing 10 to reduce resonance peaks generated by high-frequency vibration. In addition, the housing 10 of the sound production device provided by the present disclosure has a higher thermal conductivity, so that the heat conduction and heat dissipation performance of the sound production device is better.

Furthermore, the housing 10 in Example 1 and the housing 10 in Comparative Example 1 were respectively assembled with the sound production unit 20 to obtain different sound production devices, and each sound production device was acoustically tested to obtain a THD (harmonic distortion) graph as shown in FIG. 5. Here, the horizontal axis represents a sound production frequency (Hz) of the sound production device, and the vertical axis represents a ratio (%) of an effective value of output signal generated by the harmonic distortion to an effective value of the total output signal at a corresponding sound production frequency.

It can be seen from FIG. 5 that in the same sound frequency band, the sound production device prepared by using the housing 10 of Example 1 of the present disclosure had a significantly smaller output signal generated by the harmonic distortion than that using the housing 10 in Comparative Example 1, indicating that when the housing 10 provided by the present disclosure is used in the sound production device, the harmonic distortion of sound signal is smaller, thereby improving the acoustic performance of the sound production device.

It should be noted that the above embodiments focus on describing the differences between the various embodiments. Different optimization features between the various embodiments can be combined to form preferred embodiments as long as they are not contradictory. Considering the simplicity of the text, it will not be repeated here.

Although some specific embodiments of the present disclosure have been described in detail through examples, those skilled in the art should understand that the above examples are only for illustration rather than for limiting the scope of the present disclosure. It will be appreciated by those skilled in the art that modifications may be made to the above embodiments without departing from the scope and spirit of the present disclosure. The scope of the present disclosure is defined by the appended claims.

1. A housing of a sound production device, wherein at least a part of the housing is a first support housing, and the first support housing comprises a metal frame and an organic aerogel material, wherein the metal frame is a porous framework with a pore channel structure, and the organic aerogel material is distributed on a surface of the metal frame and in the pore channel structure.

2. The housing of the sound production device of claim 1, wherein a size of the metal frame in a thickness direction of the first support housing is 0.1 mm to 3 mm.

3. The housing of the sound production device of claim 1, wherein the metal frame has a surface density of 0.4 kg/m² to 1.5 kg/m²; and/or, the pore channel structure has a pore size of 80 μm to 400 μm.

4. The housing of the sound production device of claim 1, wherein the metal frame is a metal woven mesh or a metal hollow mesh; or,
the metal frame is made of metal fiber porous material or open-cell metal foam material.

5. The housing of the sound production device of claim 1, wherein the first support housing has a bending modulus of 1 GPa to 10 GPa; and/or,
the first support housing has a bending strength of 30 MPa to 100 MPa.

6. The housing of the sound production device of claim 1, wherein the first support housing has a density of 0.3 g/cm³ to 1.2 g/cm³.

7. The housing of the sound production device of claim 1, wherein the first support housing has a thickness of 0.2 mm to 3 mm.

8. The housing of the sound production device of claim 1, wherein the first support housing has a shrinkage rate of 5% to 10%.

9. The housing of the sound production device of claim 1, wherein the first support housing has an impact strength of 9 kJ/m² to 80 kJ/m².

10. The housing of the sound production device of claim 1, wherein the first support housing has a thermal conductivity greater than or equal to 1 W/m*K.

11. The housing of the sound production device of claim 1, wherein a mass of the organic aerogel material accounts for 30% to 70% of the total mass of the first support housing.

12. The housing of the sound production device of claim 1, wherein the organic aerogel material is at least one selected from the group consisting of polyimide aerogel, polyamide aerogel, polyester aerogel, aldehyde aerogel, polyolefin aerogel and polysaccharide aerogel.

13. The housing of the sound production device of claim 12, wherein the metal frame and the organic aerogel material are integrally formed by injection molding or mold pressing.

14. The housing of the sound production device of claim 1, wherein the housing further comprises a second support housing, wherein the second support housing is connected to the first support housing by integral injection molding or by adhesive; and
wherein the second support housing is made of at least one selected from the group consisting of PC and its modified material, PA and its modified materials, PPS and its modified materials, PP and its modified materials, ABS and its modified materials, LCP and its modified materials, PEI and its modified materials, phenolic resin and its modified materials, epoxy resin and its modified materials, unsaturated polyester and its modified materials, stainless steel and aluminum alloy, magnesium alloy, and metal-based composite materials.

15. A sound production device, comprising a sound production unit, and the housing of the sound production device of claim 1,
wherein the sound production unit is disposed in the housing.

16. An electronic apparatus, comprising the sound production device of claim 15.
